(19) United States
(12) Patent Application Publication
(10) Pub. No.: US 2009/0273179 A1
(43) Pub. Date: Nov. 5, 2009

(54) RESEALABLE LABEL FLAP HAVING MULTIPLE SEPARABLE LAYERS FOR DISPLAYING INFORMATION

(75) Inventors: Barry M. Scott, West Bend, WI (US); James F. Konicke, Muskego, WI (US)

Correspondence Address: ANDRUS, SCEALES, STARKE & SAWALL, LLP, 100 EAST WISCONSIN AVENUE, SUITE 1100, MILWAUKEE, WI, 53202, US

(73) Assignee: PRIME LABEL & SCREEN, INC., Pewaukee, WI (US)

(21) Appl. No.: 12/112,653

(22) Filed: Apr. 30, 2008

(51) Int. Cl. B42D 15/00; B65D 65/26

(52) U.S. Cl. 283/81; 229/87.05

(57) ABSTRACT

A resealable label flap has multiple separable layers positionable to cover an opening in a package containing removable articles. The label flap includes a base layer extending between a first end and a second end. The base layer includes a first adhesive that permits repeated application and separation of the base layer from the package. The base layer has a starting tab devoid of the first adhesive contained on the second end. A top layer is separably attached to the base layer. A top layer includes a second adhesive that permits repeated application and separation of the top layer from the release coating of the base layer. The top layer and the second adhesive have at least one access slit overlying the starting tab for facilitating separation of the top layer from the base layer when the base layer has been separated from the package. The base layer and the top layer are printed with text and/or graphics to supplement information printed elsewhere on the package.

### BACKGROUND OF THE INVENTION

The present invention relates to a resealable label flap positionable to cover an opening in a product package containing removable articles such that the label flap can be repeatedly removed and reapplied to access the articles contained within the package. More specifically, the present invention relates to a multi-layer, resealable label flap having easily separable top and base layers that provide a variety of printed text and graphics to supplement information printed elsewhere on the product package.

Resealable label flaps are commonly used with many different types of product packages. One common type of package that utilizes a resealable label flap includes packaged sheet-like removable articles that have been thoroughly wetted with a liquid prior to packaging. This specific product package is generally constructed from a thin, liquid-impervious material that has an opening over which the label flap is removably adhered. Typically, the label flap is a strip of flexible or semi-rigid thermoplastic material having a removable pressure-sensitive adhesive applied to one surface of the label flap. The removable adhesive creates a generally air-tight seal around the package opening to prevent the packaged removable articles from drying out during storage.

In the field of resealable label flaps, there is a need in packaging to convey additional information, such as nutritional, safety, instructional, promotional, regulatory or multi-language information. This information can be presented on other parts of the product package; however, the additional information sometimes creates a cluttered appearance and detracts from the visual, aesthetic appeal of the package.

One known method of presenting additional information to a consumer is disclosed in U.S. Pat. No. 5,284,363 to Gartner et al. The '363 patent shows a two ply label that utilizes a release coating on a portion of a base ply to permit a top ply to be peeled back to reveal additional information. This patent teaches the use of a resealable top ply, with a starting tab, to provide access to the additional information. However, it is problematical to use this teaching if the base ply is part of a resealable label flap because it is difficult to initiate the separation of the top and base plies when the separation point directly overlaps the starting tab of the resealable ply. Although it is possible to reverse the direction so that the separation point is at the opposite end of the starting tab of the resealable ply, this creates confusion for the consumer. The consumer will not know which end to peel back for more information and which end to peel back to access the product. Furthermore, in the reverse configuration, the top resealable ply could be peeled back so far that it starts the lifting action of the resealable base ply. The use of a resealable top ply thus presents challenges when utilized in a resealable label flap. One specific challenge is that it is difficult to get the leading area of the top ply started, if it is located directly over the starting tab of the resealable base ply.

Therefore, it is an object of the present invention to provide a resealable label flap having easily separable top and base layers that can display additional information when used on a product package. It is an additional object of the present invention to provide a resealable label flap having a resealable top layer provided with an access slit strategically located relative to a starting tab of a resealable base layer. It is a further object of the present invention to provide a resealable label flap with separable layers than can be resealably attached to product packaging without being completely removed therefrom so as to protect the contents of the packaging from contamination or drying out.

### SUMMARY OF THE INVENTION

The present invention is a resealable label flap having multiple separable layers positionable to cover an opening in a package containing removable articles. The resealable label flap includes a base layer extending between a first end and a second end. The base layer includes a first adhesive on the bottom surface that permits repeated application and separation of the base layer from the package. The base layer has a starting tab and a release coating on the top surface opposite the first adhesive.

The label flap further includes a top layer separably attached to the base layer. The top layer includes a second adhesive that permits repeated application and separation of the top layer from the release coating of the base layer. The top layer and the second adhesive have at least one access slit formed on the base layer for facilitating separation of the top layer from the base layer, such as after the base layer has been separated from the package or before the label flap has been removed from the package.

The release coating extends over a portion of the top surface of the base layer. The base layer and the top layer are permanently joined together at one end, and are separable from one another at an opposite end. The top surface of both the base layer and the top layer are preferably printed with information. Additionally, the bottom surface of the top layer can also include printed information.

In another aspect of the invention, the resealable label flap includes a base layer having a bottom face surface positionable in contact with the package and an opposed top face surface covered with a release coating. The bottom face surface includes a first adhesive applied thereto that permits repeated application and separation of the base layer from the package. The first adhesive has a masking layer applied over it to create a starting tab at one end. The top layer has a bottom face surface and an opposed top face surface. The bottom face surface of the top layer includes a second adhesive applied thereto that permits repeated application and separation of the top layer from the release coating on the base layer. The top layer and the second adhesive are formed with at least one access slit for facilitating separation of the top layer from the base layer when the base layer. In one embodiment, the access slit overlies the starting tab.

A portion of the second adhesive securely bonds the top layer to the base layer at the first end. The release coating extends over a portion of the top face surface of the base layer. The top layer is co-extensive with the base layer. The first adhesive is a preferably a removable pressure-sensitive adhesive and the second adhesive is a permanent pressure-sensitive adhesive. The top face surfaces of the base layer and the top layer are printed with information. Additionally, text can be printed on the back face surface of the top layer. In a preferred embodiment, the access slit is formed diagonally through the top layer and the second adhesive at a corner of the top layer.

The invention also contemplates a resealable package incorporating the resealable label flap as described above.

Various other features, objects and advantages of the invention will be made apparent from the following description taken together with the drawings.

### BRIEF DESCRIPTION OF THE DRAWINGS

The drawings illustrate the best mode presently contemplated of carrying out the invention.

In the drawings:

FIG. 1 is a perspective view of a resealable product package incorporating the separable, multiple layer resealable label flap of the present invention in a partially open position;

FIG. 2 is another perspective view similar to FIG. 1 showing partial separation of the multiple layers of the resealable label flap;

FIG. 3 is a perspective view similar to FIG. 1 showing the resealable label flap in a fully open position permitting removal of the articles from the product package;

FIG. 4 is a perspective view showing further separation of the multiple layers of the resealable label flap; and

FIG. 5 is a longitudinal cross section view of the resealable label flap.

### DETAILED DESCRIPTION OF THE INVENTION

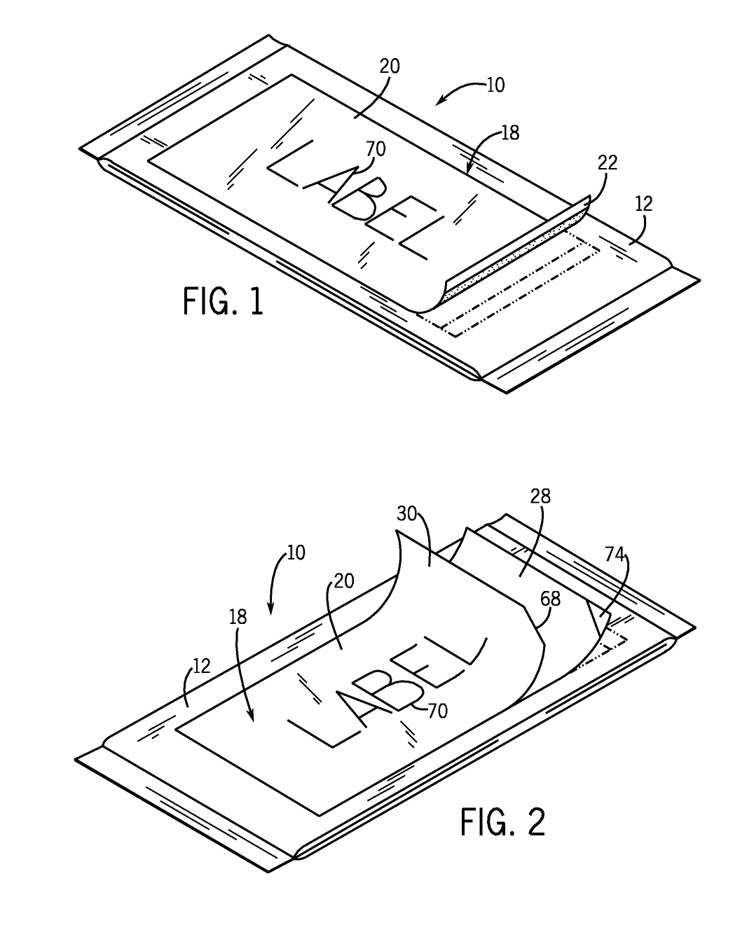

FIGS. 1-4 generally illustrate a resealable product package 10 having a main package body 12 formed by a cylinder of liquid-impervious flexible thermoplastic material heat sealed on each end to define an internal space for housing the removable articles contained within the product package 10. In the embodiment of the invention illustrated in FIGS. 1-4, the contents of the product package 10 comprise a series of stacked, individual cleaning cloths 14 that can be impregnated with appropriate cleaning solutions. For example, the cleaning cloths could be wetted baby wipes or hand towels. Although a specific product package is shown in the Figures, other types of packages for containing other types of products are contemplated. For example, the package could be a carton, lid or other shape that utilizes a resealable label flap.

The package body 12 includes an opening 16 through the package body 12 to provide access into the internal space of the package body 12 containing the cleaning cloths 14. As can be readily understood, the individual products contained in the product package 14 can be removed from the internal space defined by the package body 12 through the opening 16.

The product package 10 further includes a removable label flap 18 that is applied to the package body 12 to seal the package body by covering the opening 16. The label flap 18 contacts the generally smooth, flat top surface of the package body 12 and forms a generally water and air-tight seal with the package body 12 around the opening 16. The water and air-tight seal around the opening 16 prevents contamination of the cleaning cloths 14 and prevents the cleaning cloths 14 from drying out.

The label flap 18 is resealably attachable to the upper surface of the package body 12 such that the label flap 18 can be repeatedly opened and resealed to provide access to the cleaning cloths 14 contained within the internal space defined by the package body 12. The label flap 18 includes a main body portion 20 and a starting tab 22. In general, the bottom surface of the main body portion 20 includes a removable adhesive that allows the label flap 18 to be repeatedly peeled from the package body 12 and reapplied thereto in order to gain access to the opening 16 and then reseal the product package 10. The resealable adhesive contained on the main body portion 20 generally retains its adhesive properties during repeated application and removal of the main body portion 20 to the package body 12.

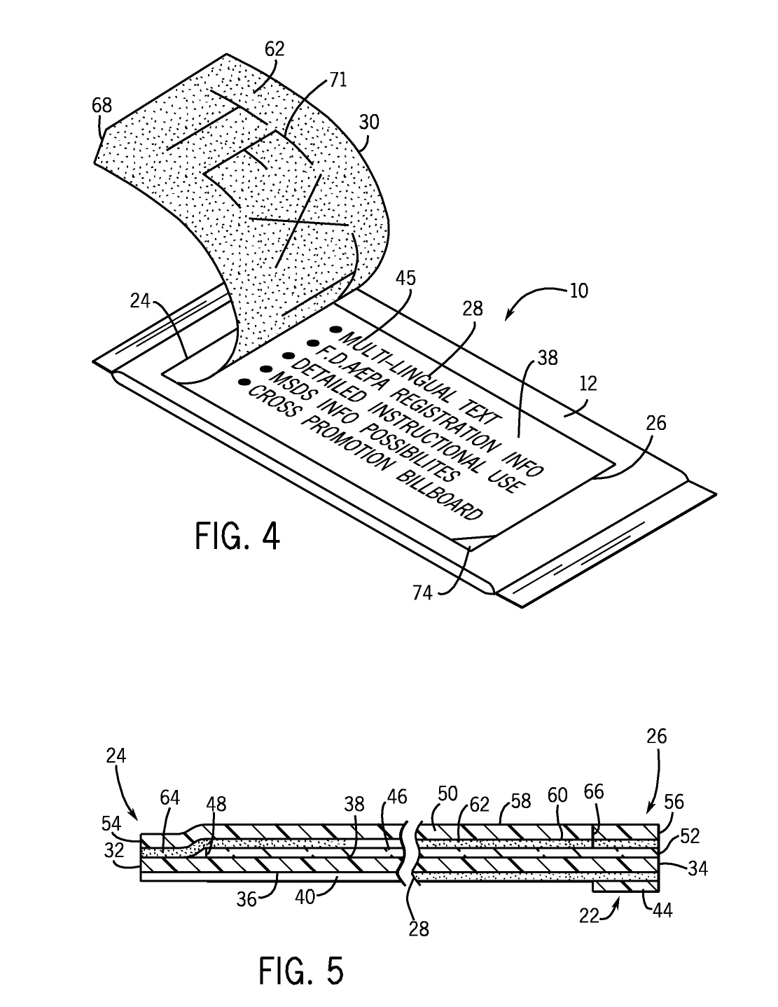

The starting tab 22 is a portion of the label flap 18 in which the adhesive on the label flap 18 is rendered ineffective or, in the alternative, not present such that the starting tab 22 can be grasped by the user to pull the label flap 18 from the package body 12. Referring now to FIGS. 4-5, the label flap 18 generally extends between a first, attachment end 24 and a second, removable end 26 which includes the starting tab 22.

As can be best seen in FIG. 5, the label flap 18 is a multi-layered member comprising a base layer 28 and a top layer 30 separably attached to and co-extensive with the base layer 28. The base layer 28 extends between a first end 32 and a second end 34, and has a thickness defined by a bottom face surface 36 and an opposed top face surface 38. The bottom face surface 36 of the base layer 28 includes a first adhesive 40 applied on the entire surface area of the bottom face surface 36. A masking layer or coating 44 is applied over the first adhesive 40 at the removable end 26 to define the starting tab 22. In an alternative embodiment, the first adhesive 40 may not be present along the portion of the bottom face surface 36 to define the starting tab 22.

In the preferred embodiment of the invention, the base layer 28 is a polymeric film, and the first adhesive 40 applied to the base layer 28 is a removable pressure-sensitive adhesive that retains its adhesive qualities as the label flap 18 is separately peeled from the package body 12 and reapplied thereto. The first adhesive 40 has the desired adhesive properties to form a seal around the opening 16 while being able to be pulled from the package body 12 without damaging the thermoplastic material forming the package body 12.

The top face surface 38 of the base layer 28 is preferably printed with indicia 45, such as text or graphic images, as illustrated in FIG. 4. Such indicia 45 may conveniently include nutritional, safety, instructional, promotional, regulatory, multi-language or other information to supplement the information carried on other parts of the package body 12. If desired, the top face surface 38 may be left unprinted. At least a portion of the top face surface 38 is covered with a transparent release coating 46 (FIG. 5) that defines a peelable area for the top layer 30. In the embodiment shown in FIG. 5, the release coating 46 extends between a first end 48 and a second end 52 aligned with the second end 34 of base layer 28.

As discussed, the label flap 18 is a multi-layer structure including the top layer 30 that is separably attached to the base layer 28. The top layer 30 extends between a first end 54 and a second end 56. Preferably, the first end 54 of the top layer 30 is aligned with the first end 32 of the base layer 28 such that the combination of the base layer 28 and the top layer 30 define the attachment end 24 of the label flap 18.

The top layer 30 includes a top face surface 58 and a bottom face surface 60. A second adhesive 62 is applied to the entire bottom face surface 60 of the top layer 30 as shown in FIG. 5. A portion 64 of the second adhesive 62 is securely bonded to the top face surface 38 of the base layer 28 at the attachment end 24. The remaining portion of the second adhesive 62 overlies the release coating 46. The second adhesive 62 is a permanent pressure-sensitive adhesive that retains its adhesive quality so that the top layer 30 can be repeatedly peeled from the release coating 46 on base layer 28 and reapplied thereto. The secure bonding of the base layer 28 and the top layer 30 at portion 64 of a second adhesive 62 prevents the complete removal of the top layer 30 from the base layer 28 during normal usage of the label flap 18 as shown in FIG. 4.

To facilitate the separation of the top layer 30 from the base layer 28, the top layer 30 and the second adhesive 62 are formed therethrough with at least one access slit 66. In a preferred embodiment, the slit 66 extends at least partially over the starting tab 24. The access slit 66 defines an area of separation for the top layer 30. When the top layer 30 is bent along the access slit 66, an edge of the top layer can be grasped. In the preferred embodiment, the slit 66 creates a diagonal side edge 68 at the lower right hand corner of the top layer 30 and the second adhesive 62. However, it should be understood that the slit 66 may have multiple locations through the top layer 30 and the second adhesive 62 to make it easy to access. The slit 66 may also take multiple shapes, such as a half circle, as long as the slit(s) extends partially over the starting tab 24 since this location permits a user of the label flap to easily grab, bend and start the peeling action of the top layer 30 from the base layer 28 once at least the starting tab 24 of the base layer 28 has been separated from the package 10.

The top layer 30 is preferably a paper or polymeric film that is printed with text and/or graphic images on the top face surface 58 as represented by numeral 70 in FIG. 1. The second adhesive 62 applied to the bottom face surface 60 of the top layer 30 may be printed with additional text and/or product information, as shown by reference numeral 71.

When the label flap 18 is positioned on the package body 12, the removable first adhesive 40 applied to the base layer 28 is pressed into contact with the package body 12, and the base layer 28 covers the entire opening 16.

When a user desires to access the products 14 contained within the package 12, the user first grabs the starting tab 22. Once the starting tab 22 has been grasped, the user pulls back on the label flap 18 as shown in FIG. 1 to overcome the removable adhesive bond between the removable first adhesive 40 and the package body 12. The user continues to pull back on the label flap 18 until the entire main body portion 20 has been pulled out of contact with the package body 12 as seen in FIG. 3.

As shown in FIG. 3, the first time the label flap 18 is pulled from the package body 12, a perforated oval covering 72 separates from the package body 12 to define the opening 16. The oval covering 72 remains adhesively attached to the label flap 18, and prevents contact between the first adhesive 40 and the cleaning cloths 14.

After the desired number of cleaning cloths 14 has been removed from the opening 16, the user repositions the label flap 18 over the opening 16. The first adhesive 40 reseals the label flap 18 onto the package body 12 to form the required air-tight seal around the opening 16.

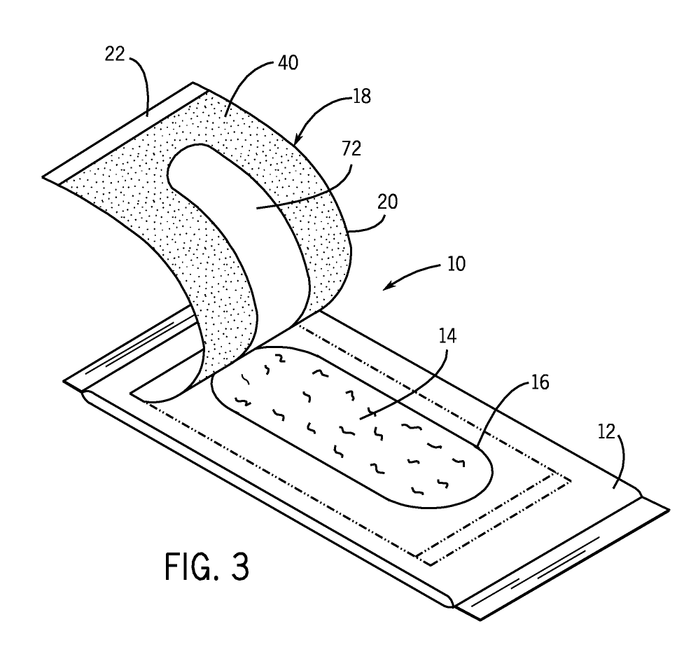

In accordance with the invention, the user may view additional information within the label flap 18 by separating the top layer 30 from the base layer 28. This can occur either while the label flap 18 is on the package or after the user has grasped the starting tab 22 and pulled back on label flap 18, as shown in FIG. 1. Using the access slit 66 extending across the starting tab 22, the user grasps the diagonal side edge 68 and easily separates the top layer 30 and the second adhesive 62 from the base layer 28 and the release coating 46 as shown in FIG. 2. This initial separation causes a small triangular portion 74 of the top layer 30 and the second adhesive 62 to remain affixed to the release coating 46 and the base layer 28 in the lower right hand corner thereof as seen in FIG. 2. The user continues to peel back the top layer 30 and its second adhesive 62 as shown in FIG. 4 until the indicia 45 and the text 71 are fully viewable. Base layer 28 may remain completely or partially sealed over the opening 16 on the package body 12. Top layer 30 and second adhesive 62 are prevented from complete removal from the label flap due to the secure bonding by second adhesive 62 at portion 64 between the top layer 30 and the base layer 28.

Although the invention has been described with a non-removable top layer 30, it may be desirable to have a fully removable top layer 30 if the top layer 30 is, for example, a game piece or a redeemable coupon. To make the top layer fully peelable from the base layer 28, the release coating 46 would be extended to cover the entire top base surface 38 of the base layer 28. It may also be desirable not to apply the release coating 46 on the base layer 28 in the small area formed by the access slit 66.

Various alternatives and embodiments are contemplated as being within the scope of the following claims particularly pointing out and distinctly claiming the subject matter regarded as the invention.

I claim:

1. A resealable label flap having multiple separable layers positionable to cover an opening in a package containing removable articles, the label flap comprising:
a base layer extending between a first end and a second end, the base layer including a first adhesive on a bottom face surface that permits repeated application and separation of the base layer from the package, the base layer having a starting tab to permit removal of the base layer from the package and a release coating on a top face surface of the base layer; and
a top layer separably attached to the base layer, the top layer including a second adhesive that permits repeated application and separation of the top layer from the release coating of the base layer, the top layer and the second adhesive having at least one access slit for facilitating separation of the top layer from the base layer when the base layer has been separated from the package.

2. The resealable label flap of claim 1, wherein the access slit overlies the starting tab.

3. The resealable label flap of claim 1, wherein the release coating extends over only a portion of the base layer.

4. The releasable label flap of claim 1, wherein the base layer and top layer are permanently joined together at one end, and are separable from one another at an opposite end.

5. The resealable label flap of claim 1, wherein the base layer and the top layer are printed with information.

6. The resealable label flap of claim 5 wherein the second adhesive applied to the top layer is printed with information.

7. A releasable label flap having multiple separable layers positionable to cover an opening in a package containing removable articles, the label flap comprising:
a base layer extending between a first end and a second end, the base layer having a bottom face surface positionable in contact with the package and an opposed top face surface covered with a release coating, the bottom face surface including a first adhesive applied thereto that permits repeated application and separation of the base layer from the package, the bottom face surface having a starting tab at the second end, and
a top layer having a bottom face surface and an opposed top face surface, the bottom face surface including a second adhesive applied thereto that permits repeated application and separation of the top layer from the release coating on the base layer, the top layer and the second adhesive being formed therethrough with at least one access slit for facilitating separation of the top layer from the base layer.

8. The releasable label flap of claim 7, wherein a portion of the second adhesive securely bonds the top layer to the base layer at the first end.

9. The releasable label flap of claim 7, wherein the release coating extends over only a portion of the top face surface of the base layer.

10. The releasable label flap of claim 7, wherein the top layer is co-extensive with the base layer.

11. The releasable label flap of claim 6, wherein the first adhesive is a removable pressure-sensitive adhesive and the second adhesive is a permanent pressure-sensitive adhesive.

12. The releasable label flap of claim 7, wherein the top face surfaces of the base layer and the top layer are printed with information.

13. The resealable label flap of claim 12 wherein the second adhesive applied to the top layer is printed with information.

14. The releasable label flap of claim 7, wherein the access slit is formed diagonally through the top layer and the second adhesive at a corner of the top layer overlying the starting tab.

15. A resealable package comprising:
a package body having an internal space sized to contain a plurality of removable articles;
an opening through the package body to the internal space for accessing the removable articles; and
a resealable label flap positioned on the package to cover the opening in the package, the label flap including:
a base layer extending between a first end and a second end, the base layer having a bottom face surface positionable in contact with the package and an opposed top face surface at least partially covered with a release coating, the bottom face surface including a first adhesive applied thereto that permits repeated application and separation of the base layer from the package, the bottom face surface having a starting tab located at the second end; and
a top layer having a bottom face surface and an opposed top face surface, the bottom face surface including a second adhesive applied thereto that permits repeated application and separation of the top layer from the release coating on the base layer, the top layer and the second adhesive being formed therethrough with at least one access slit for facilitating separation of the top layer from the base layer.

16. The resealable package of claim 15 wherein the access slit overlies the starting tab.

17. The resealable package of claim 15, wherein the top face surfaces of the base layer and the top layer are printed with information.

18. The resealable label flap of claim 15 wherein the second adhesive applied to the top layer is printed with information.

19. The resealable label flap of claim 15 wherein the release coating substantially covers all of the top face surface of the base layer except a portion of the base layer at the first end.
